(19) United States
(12) Patent Application Publication
(10) Pub. No.: US 2003/0152192 A1
(43) Pub. Date: Aug. 14, 2003

(54) X-ray analyzer

(76) Inventor: Kiyoshi Hasegawa, Chiba-shi (JP)

Correspondence Address: ADAMS & WILKS, 31st Floor, 50 Broadway, New York, NY, 10004, US

(21) Appl. No.: 10/349,883

(22) Filed: Jan. 23, 2003

(30) Foreign Application Priority Data
Jan. 31, 2002 (JP) 2002-022824

(51) Int. Cl. G01N 23/06

(52) U.S. Cl. 378/53

(57) ABSTRACT

The present invention is intended to achieve an X-ray irradiation region of arbitrary size without enlarging the area of a collimator section. An X-ray analyzer comprises an X-ray generating section for generating primary X-rays, an X-ray detection section for detecting secondary X-rays from a sample, and a collimator section for restricting primary X-rays irradiated to the sample, the collimator section being provided with two X-ray shields having at least one L-shaped edge, the two X-ray shields being aligned so as to form a rectangular or square opening. Mechanisms are provided for moving the two X-ray shields so that the shape and size of the X-ray irradiation region can be changed.

### BACKGROUND OF THE INVENTION

1. Field of the Invention

The present invention relates to an X-ray analyzer for detecting secondary X-rays emitted from a sample when a sample is irradiated with X-rays, and performing analysis of the sample.

2. Description of the Related Art

The related art will now be described with reference to FIG. 2. With a conventional X-ray analyzer, an X-ray irradiation region 16 can be acquired by passing primary X-rays 5 irradiated from an X-ray generating section 1 through a hole 13 of predetermined fixed size provided in a collimator section 16. In order to vary the size of the irradiation region 16, the collimator section 11 is caused to move in a movement direction 14 so that a hole 12 of another size formed in advance in the collimator section 11 is brought to a specified position, thus varying the size of the X-ray irradiation region 16.

However, with the conventional method, since the X-ray irradiation region is determined by causing passage through a hole of fixed size formed in advance in the collimator section, it is only possible to obtain a prepared X-ray irradiation region, and there is a problem that it is not possible to carry out fine adjustment to the required size. If there is also likely to be an increase in the number of types of region, then a number of holes will be required according to the number of types of region, which means that there is a problem that it is necessary for the collimator section to take up a large area.

### SUMMARY OF THE INVENTION

The present invention is aimed at realizing X-ray irradiation regions of arbitrary shape and size without increasing collimator area.

In order to achieve the above described aims, the present invention adopts the following means. Specifically, an X-ray analyzer comprises an X-ray generating section for generating primary X-rays, an X-ray detection section for detecting secondary X-rays from a sample, and a collimator section for restricting primary X-rays irradiated to the sample, with the collimator section being provided with two X-ray shields having at least one L-shaped edge, and the two X-ray shields being aligned so as to form a square opening to restrict an X-ray irradiation region where a sample is irradiated. There is also a mechanism for allowing movement of the two X-ray shields, and the shape and size of the X-ray irradiation region can be varied by moving the X-ray shields.

### BRIEF DESCRIPTION OF THE DRAWINGS

FIG. 1 is an example of the structure of a device embodying the present invention.

FIG. 2 is an example of the structure of a device embodying the related art.

FIG. 3 shows an X-ray shield constituting an X-ray collimator.

FIG. 4 shows an example of moving one X-ray shield in a lateral direction to change an irradiation region.

FIG. 5 shows an example of moving two X-ray shields in a lateral direction to change an irradiation region.

FIG. 6 shows an example of moving one X-ray shield in a direction of 45 degrees to change an irradiation region.

FIG. 7 shows an example of moving two X-ray shields in a direction of 45 degrees to change an irradiation region.

FIG. 8 shows an example of moving one X-ray shield in a longitudinal and lateral direction to change an irradiation region.

FIG. 9 shows an example of moving two X-ray shields in a longitudinal and lateral direction to change an irradiation region.

FIG. 10 shows an example of the structure of a device for aligning an X-ray irradiation region to be changed and a measurement sample.

FIG. 11 shows an example matching size of a measurement sample and varying size of an X-ray irradiation region.

FIG. 12 shows an example matching size of a measurement sample and varying size of an X-ray irradiation region.

### DETAILED DESCRIPTION OF THE INVENTION

In the following, embodiments of the present invention will be described with reference to the drawings, and will become particularly clear with reference to an example of a fluorescence X-ray analyzer as a typical example of an X-ray analyzer.

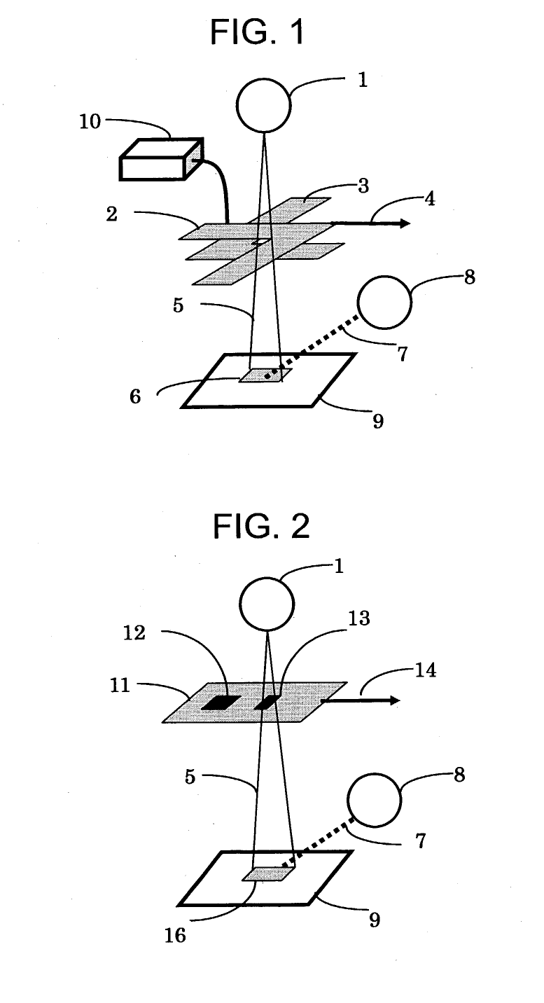

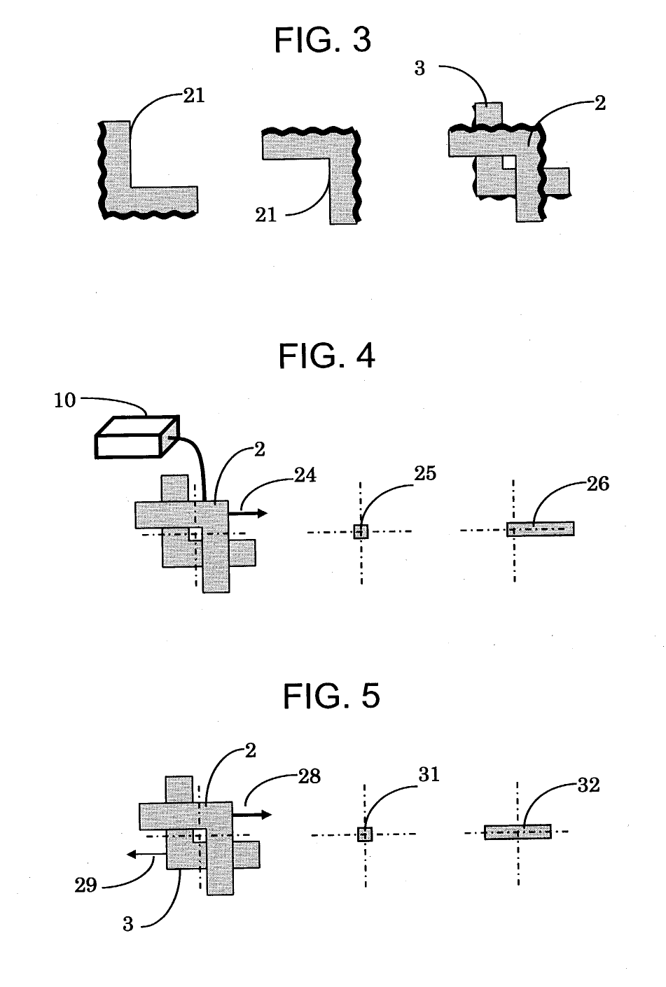

First of all, the structure of a device constituting the basis of the present invention will be described based on FIG. 1 and FIG. 3. In FIG. 1, an X-ray generating section 1 uses an X-ray tube, while an X-ray shield 2 moving in a horizontal direction (direction 4) and an X-ray shield 3 having a fixed position use a metal plate or the like capable of shielding primary X-rays 5. The material and thickness of the X-ray shields 2 and 3 differ depending on the primary X-ray acceleration voltage and X-ray tube power, but in the case where it is desired to achieve a microscopic X-ray irradiation region, a material that has a fixed X-ray shielding capability or more while at the same time having good workability is preferable, for example, iron, copper or tungsten. This is because the linearity of the edges of the X-ray shields is important since an X-ray passing surface constructed from the X-ray shields determines the shape of the X-ray irradiation region. In a stage where material of the X-ray shields has been determined, it is preferable that that material has the required thickness to shield X-rays.

As shown in FIG. 3, the two X-ray shields 2 and 3 constituting the collimator section are both prepared in an L-shape, and in use inner L-shaped edges 21 are overlapped to as to be able to form a square or a rectangle. At this time, a rectangle formed in the center determines size and shape of an X-ray irradiation region. Therefore, the X-ray shield 2 and the X-ray shield 3 preferably have inner edges 21 formed in an L-shape for determining a surface for passing X-rays. Primary X-rays passing through a rectangular gap formed by the X-ray shield 2 and the X-ray shield 3 of FIG. 1 are irradiated to an X-ray irradiation region 6 within a measurement sample 9.

Next, a method of varying the size of the X-ray irradiation region by causing horizontal movement of one X-ray shield will be described based on FIG. 4. In FIG. 4, the X-ray shield 2 is provided with an X-ray shield movement mechanism 10 having a guide rail and a pulse motor, and being capable of left and right horizontal movement, causing the X-ray shield 2 to be moved in a movement direction 24. At this time, a square formed by the X-ray shield 2 and the X-ray shield 3 accompanying movement of the X-ray shield 2 has its size varied in the horizontal direction. With this operation, the X-ray irradiation region 25 is changed to the X-ray irradiation region 26. By adjusting an amount of feed of the pulse motor, it is possible to arbitrarily set the shape and size of the X-ray irradiation region.

In a further embodiment, there is provided an X-ray shield moving mechanism for moving the two X-ray shields horizontally, and a method of varying the size of an X-ray irradiation region without varying the center of the X-ray irradiation region by causing the two X-ray shield to move equally will be described based on FIG. 5. The X-ray shield 2 and X-ray shield 3 of FIG. 5 are provided with an X-ray shield moving mechanism capable of movement in the left or right direction, and driven by a pulse motor. Since the two X-ray shields are caused to move the same distance in respectively opposite directions (movement directions 28 and 29) at the same time, an amount of movement set in the moving mechanism is set to half the normal amount. By using this method the X-ray |irradiation region |31, it is possible to obtain an X-ray irradiation region 32 in a state where the width of the X-ray irradiation region has been enlarged while maintaining a central position.

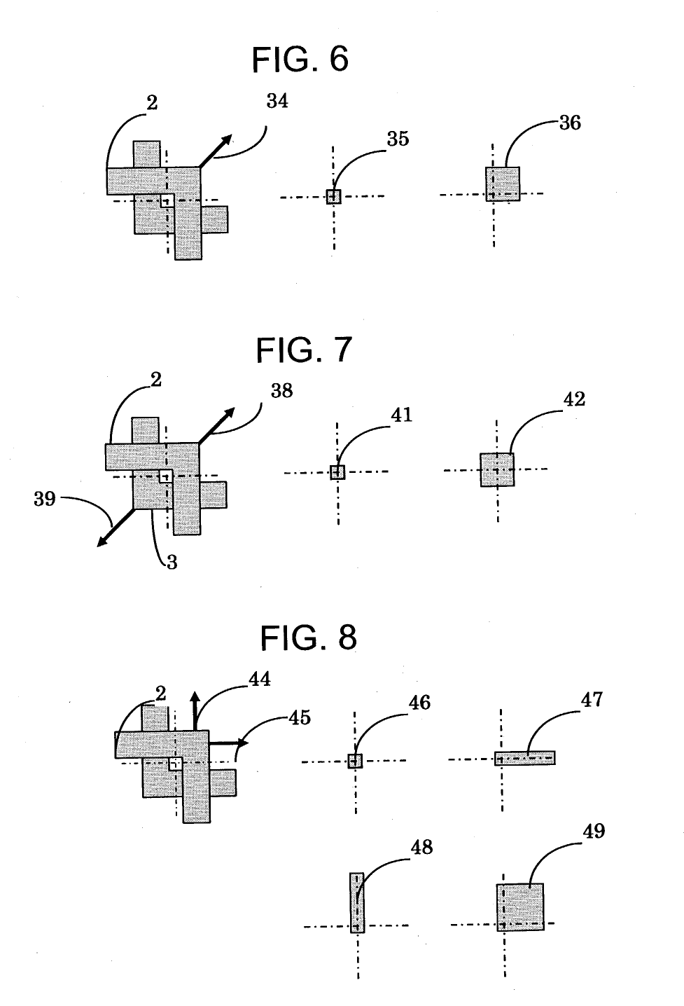

Next, a method of realizing rectangular X-ray irradiation regions of differing size by causing movement of the X-ray shield moving device in a direction at 45° to a right angle formed by the L-shape of the X-ray shield will be described based on FIG. 6. The X-ray shield 2 of FIG. 6 is provided with an X-ray shield moving mechanism capable of movement in a direction sloping right upwards at 45° (movement direction 34) and driven by a pulse motor. An amount of movement set in the moving mechanism is set to 2^{1/2} times the size of the X-ray irradiation region it is wished to change. By moving the X-ray shield 2 in the movement direction 34, it is possible to equally vary the length and breadth of the X-ray irradiation region 35 while maintaining the square shape to obtain the X-ray irradiation region 36.

A method of realizing square X-ray irradiation regions of differing size without changing a central position of the X-ray irradiation region will be described based on FIG. 7. In FIG. 7, the X-ray shield 2 and the X-ray shield 3 are provided with an X-ray shield moving mechanism for moving the shields respectively in directions inclined at 45° (movement directions 38 and 39), and driven by a pulse motor. A movement amount set in the X-ray shield moving mechanism is designated as 2^{1/2}/2 times the size of the X-ray irradiation region it is wished to change. Using this operation, the X-ray irradiation region 41 is changed to the X-ray irradiation region 42 while maintaining the square shape and also the central position.

Next, a method of varying the size of an X-ray irradiation region independently in the horizontal direction and vertical direction by causing movement of an X-ray shield moving mechanism in horizontal and vertical directions with respect to an edge forming an L-shape of one X-ray shield will be described. In FIG. 8, the X-ray shield 2 is provided with an X-ray shield moving mechanism capable of movement in a longitudinal direction (movement direction 44) and a lateral direction (movement direction 45) and driven by a pulse motor. The X-ray irradiation region 46 is changed to a horizontally oriented rectangular X-ray irradiation region, namely the X-ray irradiation region 47, when the X-ray shield 2 is moved in the movement direction 45. Also, the X-ray irradiation region 46 is also changed to a vertically oriented rectangular X-ray irradiation region, namely the X-ray irradiation region 48, if the X-ray shield 2 is moved in the movement direction 44. If the X-ray shield 2 is moved in the movement direction 45 and then moved in the movement direction 44, the X-ray irradiation region 46 is changed to the X-ray irradiation region 49. In this case, if the X-ray irradiation region 46 is a square and the amount of movement is the same in the movement direction 44 and the movement direction 45, the X-ray irradiation region 49 will become a square.

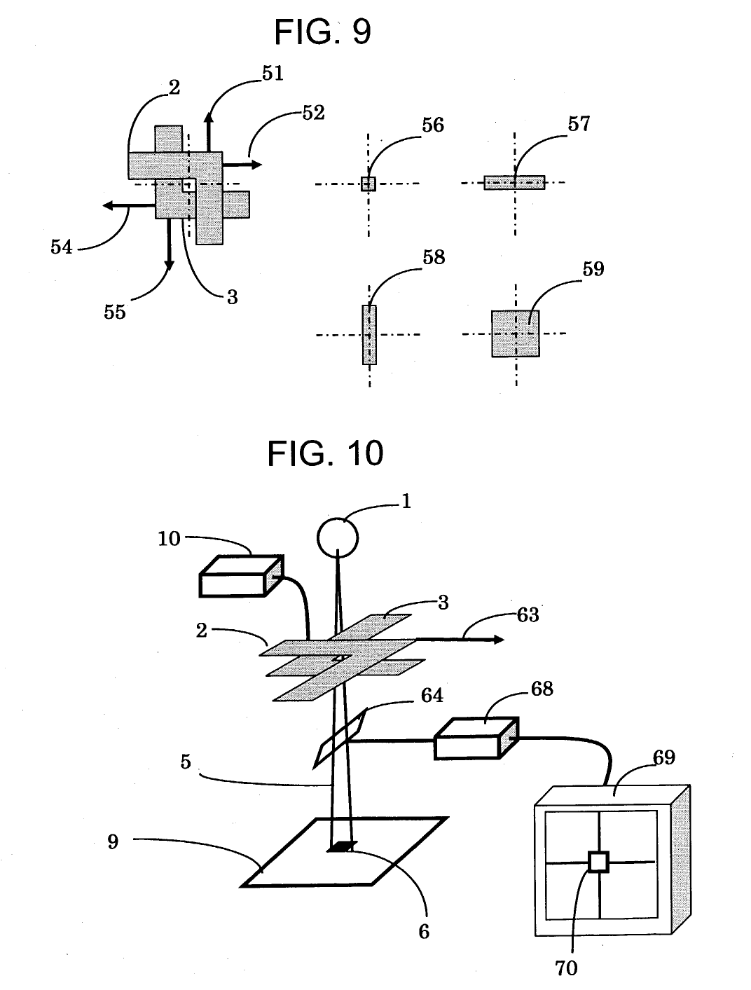

The state of causing variation in the size of the X-ray irradiation region independently in the vertical direction and the horizontal direction without changing a central position of the X-ray irradiation region is shown in FIG. 9. The X-ray shield 2 and the X-ray shield 3 are respectively provided with an X-ray shield movement mechanism for moving longitudinally and laterally, and driven by a pulse motor. Height and width of the X-ray irradiation region can be controlled while maintaining the central position by causing equal movement of the X-ray shield 2 and the X-ray shield 3 in opposite directions.

For example, by moving the X-ray shield 2 in the movement direction 52 and moving the X-ray shield 3 in the movement direction 54 by the same amount, the X-ray irradiation region 56 is made into the X-ray irradiation region 57 that is expanded in the width direction while maintaining the central position, while if the X-ray shield 2 and the X-ray shield 3 are respectively moved by the same amount in the movement direction 51 and in the movement direction 55, the X-ray irradiation region 56 is made into the X-ray irradiation region 58 that is expanded in the depth direction while maintaining the central position. By carrying out each of the above described movement patterns at the same time, the X-ray irradiation region 56 becomes the X-ray irradiation region 59 expanded in the width and depth directions while maintaining the central position.

Next, a method of easily aligning a measurement sample with a changed X-ray irradiation region by providing an imaging section for observing the state of a sample, and a display section for displaying an image obtained by the imaging section and an X-ray irradiation region in an overlapping manner will be described based on FIG. 10. In FIG. 10, a half mirror 64 is for observing a measurement sample 6 from a primary X-ray irradiation direction. When an imaging section 68 directly images the measurement sample 6, the half mirror 64 is not required. A display section 69 displays an image of the measurement sample 6 acquired by the imaging section 68, and displays lines 70 representing the X-ray region at the same time.

The lines 70 representing the X-ray irradiation region are displayed by computing the following procedures.

(Procedure 1) Computation of size of X-ray irradiation region 6

Size of X-ray irradiation region 6 will be computed from a positional relationship between a collimator section, comprised of an X-ray generating section 1, X-ray shield 2 and X-ray shield 3, and a measurement sample 9, and the size of a square being realized by the collimator section. As an example, the size of an X-ray irradiation region has been calculated as width 2 mm depth 2 mm.

(Procedure 2) computation of field of view of image acquired by the imaging section 68

Since computed size is different depending on size of the imaging section 69 and an optical system en route, a width of 8 mm and depth of 6 mm were computed.

(Procedure 3) display of X-ray irradiation region

Size of X-ray irradiation region on the display section can be computed from field of view of the image and size of the X-ray irradiation region, and it is possible to display lines 70 representing the X-ray irradiation region.

As described above, even if an X-ray irradiation region is changed, it is possible to easily align a measurement sample by displaying the X-ray irradiation region and the measurement sample in an overlapped manner.

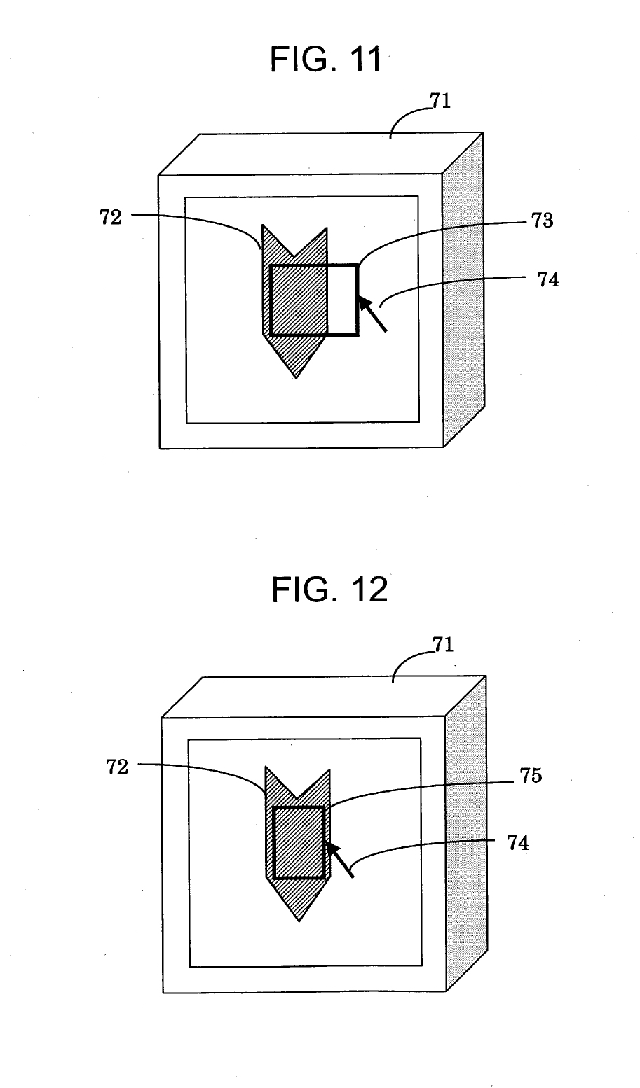

The device is also provided with operation means for designating size of an X-ray irradiation region on the display section, and a method of causing variation in size of the X-ray irradiation section while confirming a measurement sample on the display section will be described based on FIG. 11 and FIG. 12. In FIG. 11, a mouse is used as operating means for designating the size of an X-ray irradiation region, and the display section 71 displays an image 72 of a measurement sample and lines 73 representing the X-ray irradiation region, and a mouse cursor 74 is also displayed on the display section. With this example, description will be given assuming a device where one of the X-ray shields of FIG. 4 is made to move in the lateral direction to enable change in the width of the X-ray irradiation section.

In FIG. 11, the lines 73 representing the X-ray irradiation region jut out with respect to the image 72 of the measurement sample, and if measurement is carried out in this state, measurement will also be performed with primary X-rays irradiated to sections where there is no measurement sample. When it is desired to have the entire measurement sample existing at all areas inside the X-ray irradiation region, the right end of the lines 73 representing the X-ray irradiation region is selected using the mouse and an operation carried out to reduce the width of the rectangle representing the X-ray irradiation region. The result of the operation is line 74 representing the X-ray irradiation region of FIG. 12. The device carries out operations in the procedures shown below so as to irradiate X-rays to the line 74 representing the X-ray irradiation region.

(Procedure 1) computation of field of view of image acquired by the imaging section

(Procedure 2) conversion of lines 74 representing X-ray irradiation region to size on measurement sample

X-ray irradiation region is computed from relationship between field of view of image and the lines 74 representing the X-ray irradiation image.

(Procedure 3) change of X-ray irradiation region

Amount of movement of the X-ray shield is computed from a positional relationship between the X-ray generating section, two X-ray shields and the measurement sample, a position of the collimator section determined by the two X-ray shields, and the computed X-ray irradiation region, the X-ray shield is moved and the X-ray irradiation region is changed.

As described above, it is possible to vary an X-ray irradiation region while confirming a measurement sample on a display section.

So far, a fluorescence X-ray analyzer has been given as an embodiment, but the present invention can also apply to X-ray Diffractometer and X-ray Scanning Analytical Microscope.

The present invention enables a rectangular or square X-ray irradiation regions by providing an X-ray analyzer, comprising an X-ray generating section for generating primary X-rays, an X-ray detection section for detecting secondary X-rays from a sample, and a collimator section for restricting primary X-rays irradiated to the sample, where the collimator section is provided with two X-ray shields having at least one L-shaped edge, with the two X-ray shields being aligned so as to form a square opening, to restrict an X-ray irradiation region where a sample is irradiated.

There is also provided an X-ray shield moving mechanism, and changes in shape and size of the X-ray irradiation region in a seamless manner are enabled by moving the X-ray shields.

It is also possible to change the size and shape of the X-ray irradiation region while maintaining a central position of the X-ray irradiation region by causing the two X-ray shields to move by the same distance in opposite directions.

It is also possible to easily align a measurement sample with respect to a changed X-ray irradiation section by further providing an imaging section for observing state of a sample, and a display section for displaying an image obtained by the imaging section and an X-ray irradiation region in an overlapped manner, to display the X-ray irradiation section and the state of the measurement sample in an overlapped measurement.

What is claimed is:

1. An X-ray analyzer comprising:
an X-ray generating section for generating primary X-rays,
an X-ray detection section for detecting secondary X-rays from a sample; and
a collimator section for restricting primary X-rays irradiated to the sample, the collimator section being provided with two X-ray shields having at least one L-shaped edge, and the two X-ray shields being aligned so as to form a square opening, to restrict an X-ray irradiation region where a sample is irradiated.

2. The X-ray analyzer according to claim 1, wherein the collimator section is provided with an X-ray shield moving mechanism for allowing horizontal movement of one of the two X-ray shields, and changes shape and size of the X-ray irradiation region.

3. The X-ray analyzer according to claim 1, wherein the collimator section is provided with an X-ray shield moving mechanism for allowing balanced horizontal movement of the two X-ray shields, and changes shape and size of the X-ray irradiation region.

4. The X-ray analyzer according to claim 2, wherein the X-ray shield moving mechanism allows movement in a direction at 45° to a right angle formed by an L-shape of an X-ray shield, and an X-ray irradiation region is made a square of arbitrary size.

5. The X-ray analyzer according to claim 3, wherein the X-ray shield moving mechanism allows movement in a direction at 45° to a right angle formed by an L-shape of an X-ray shield and opposite direction each other, and an X-ray irradiation region is made a square of arbitrary size.

6. The X-ray analyzer according to claim 2, wherein the X-ray shield moving mechanism allows movement of the X-ray shields in forward and backwards and left and right directions, and the size of the X-ray irradiation region is varied independently in a horizontal direction and a vertical direction.

7. The X-ray analyzer according to claim 3, wherein the X-ray shield moving mechanism allows movement of the X-ray shields in forward and backwards and left and right directions, and the size of the X-ray irradiation region is varied independently in a horizontal direction and a vertical direction.

8. The X-ray analyzer according to claim 1, further comprising an imaging section for observing the state of a sample and a display section for displaying an image obtained by the imaging section and an X-ray irradiation region in an overlapped manner.

9. The X-ray analyzer according to claim 8, further comprising operation means for designating size of an X-ray irradiation region on the display section, and the irradiation region is varied while confirming a measurement sample using the display section.
